(19) United States
(12) Patent Application Publication
(10) Pub. No.: US 2006/0032912 A1
(43) Pub. Date: Feb. 16, 2006

(54) Contact information management system and method

(75) Inventors: Kenneth Mitchell, Ancaster (CA); Bruce Ashley, Caledon (CA); Tony Romanin, North York (CA); Eric Loit, Mississauga (CA)

Correspondence Address: DIMOCK STRATTON LLP, 20 QUEEN STREET WEST SUITE 3202, BOX 102, TORONTO, ON, M5H 3R3, CA

(73) Assignee: 1610434 Ontario Inc., Bolton (CA)

(21) Appl. No.: 11/204,390

(22) Filed: Aug. 16, 2005

(30) Foreign Application Priority Data
Aug. 16, 2004 (CA) 2,477,506

(51) Int. Cl. G06F 7/08

(52) U.S. Cl. 235/381

(57) ABSTRACT

A system and method for efficient contact information management, and in particular business card management. A user interface is provided for entry of data for a business card record and unique numerical code is generated for each business card record. Contact information is retrievable from the business card database upon entry of the unique numerical code, and always correctly reflects the information as entered and updated by the contact. Once the unique numerical code is entered, the business contact information can be downloaded from a central database into any contact management program.

### FIELD OF INVENTION

This invention relates to information management. In particular, this invention relates to a system and method for managing contact information.

### BACKGROUND OF THE INVENTION

Most individuals have different types of contacts, and many different contacts within each type. This is especially true in a business context, where contacts might typically include customers, suppliers and service providers, general acquaintances and relationships developed for and during networking activities, and so on. The most popular method of conveying contact information, and of storing and organizing contact information, is the business card.

The business card may be the most fundamental of all business marketing tools. It is one of the first items ordered when a new business is begun, when a new employee is hired, when a promotion is received, when an office is re-located, or when a telephone or email address is changed. A business card can convey any information relevant to a contact, and is thus a multi-faceted marketing tool: it is an introductory instrument, a networking device, a business contact record, and an archive resource.

Business cards are easy to distribute and easy to accumulate. It is much more difficult to optimize utilization of received business cards. Information must be either scanned or input manually into contact manager databases, but both of these options are less than optimal. Scanners can be costly and cumbersome, and are not able to collect organizational names appearing in logos. Manual inputting of information is possible, but is time consuming and tends to be a very low-priority task, and is thus rarely actually undertaken.

It would accordingly be advantageous to provide a system and method for managing contact information. Users of such a system and method would become more productive and experience better utilization, organization and retrieval of contact information.

### SUMMARY OF THE INVENTION

The present invention provides a system and method for efficient contact information management, and in particular business card management. Geared toward the business card recipient (but advantageous in other environments as well), the invention provides an easy data entry process that encourages database entry and discourages stockpiling of business cards by busy executives, managers and staff. The invention provides one-time handling and organization of business contact information, portability, instant updates, and access to information from any Internet-connected computer.

By developing a licence and unique numerical code for each ‘business card,’ the invention enables quick entry, organization and retrieval of information on a secure web-based database. A one-number entry process ensures that business card contact information is quickly entered, and that contact information always correctly reflects the information as entered and most recently updated by the contact. Once the unique numerical code is entered, the business contact information can be downloaded from a central database into any contact management program.

These and other advantages of the invention will become apparent from the description which follows.

The present invention thus provides a method of managing contact information, comprising the steps of: a. providing an interface for the entry of user information to be stored in a contact information record in a system database, b. generating a unique identification number associated with the user and the contact record, and c. in response to entry of the identification number by a recipient into an interface, downloading information about the user from the contact information record to the recipient.

The present invention further provides a contact information management system, comprising: a host computer equipped with an application for: providing an interface for the entry of user information to be stored in a contact information record, and generating a unique identification number associated with the user and the contact record, and in response to entry of the identification number by a recipient into an interface, downloading information about the user from the contact information record to the recipient.

### BRIEF DESCRIPTION OF THE DRAWINGS

In drawings which illustrate by way of example only a preferred embodiment of the invention,

FIG. 1 is a schematic diagram illustrating the system of the invention.

FIG. 2 is a schematic diagram illustrating a number generation system for the system of FIG. 1.

FIG. 3 is a table illustrating a hashing algorithm for the number generation system of FIG. 2.

### DETAILED DESCRIPTION OF THE INVENTION

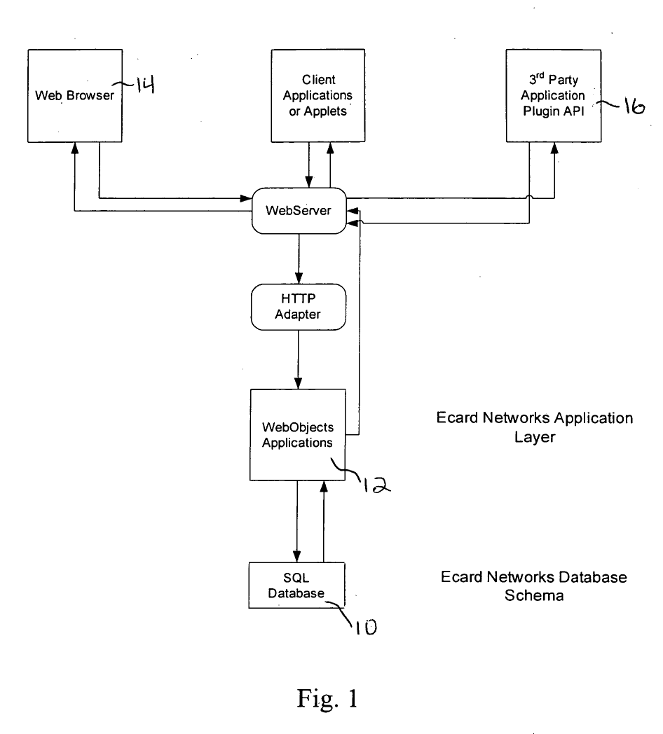

FIG. 1 illustrates a preferred embodiment of the system of the invention. A database 10 maintains contact information entered by each contact via a user interface provided by the host application 12, running on for example a standard PC. Through the use of a unique Electronic Identification (EID) number assigned to each contact record in the database 10, the host application 12 allows for retrieval of the contact information by authorized users. The invention is described in the context of business contact information, however it will be appreciated that the system and method of the invention is equally applicable to other contact information, including personal contact information.

In a typical case an EID would be created when a customer is ready to order or reorder a business card. The customer may obtain their own EID by directly accessing the host website, or may purchase an EID, for example at a print shop where their business cards are being designed and printed (the EID can be offered as a value-added item by the print shop). However, it will be appreciated that the physical business card is merely one vehicle for disseminating the EID number. The method and system of the invention can be implemented without any physical business card counterpart to the contact information record, and the EID number can be disseminated by any convenient means. For example:
It may be included in business letterhead and stationery;
It may be disseminated with email signatures;
It may be included in promotional advertising, brochure-ware and greeting cards;
It may be attached as a caption, or digitally inscribed on graduating class photographs and in school yearbooks.

The system and method of the invention are implemented over a wide area network, preferably a global computer network such as the Internet. An individual wishing to become an EID User visits the host website on a client-side computer enabled with any suitable web browser 14, and enters the information for the EID Owner and EID User (both described below), as it would appear on an actual physical business card, including a graphic file of a logo or other graphic if desired, into the user interface. Any information desired to be kept confidential need not be entered, the only required information is an EID Owner name and email address, for login purposes. Once the entry of data into the user interface information fields is complete, the information is submitted to the contact database 10 where the host application 12 checks the information for an existing contact record for the EID User. If there is an existing contact record for the EID User, the host application 12 merely updates existing information where required. If there is no existing contact record for the EID User, the database generates a unique EID number, for example in the manner described below, and in the preferred embodiment a payment screen appears enabling payment by credit or debit card. When the EID Owner's payment is validated, the EID number is issued. The EID number may be associated with other EID numbers generated for the EID Owner.

If the EID is obtained on behalf of the customer by a third party such as a printer (which might be a print house, a graphic designer, etc.), a plug-in module 16 may be provided to allow the printer to download the EID information and EID number into a standard document generating program such as Quark, PageMaker etc. The printer then proceeds to design the physical business card. If the printer changes any of the information downloaded from the database, the program queries the changes, which the printer may then accept or reject. If the printer accepts the change, the database is automatically updated. Once the design process is completed, proofs of the physical business card are generated and sent to the customer for approval. The approved business card, complete with the assigned EID number, then goes to print.

In the preferred embodiment the EID is based on a complicated hash of smaller binary data structures, in order to develop a non-sequential sparse array of EID's. The purpose of the sparse array of EID's discourages the misuse of the system to capture user info without user permission, such as developing a mass mailing list. The structure of the EID is such that ordered generation of the EID does not produce ordered EID's or sequential EID's, making a sequential EID test very difficult to perform (with the proper lockout on successive retries with NULL returns).

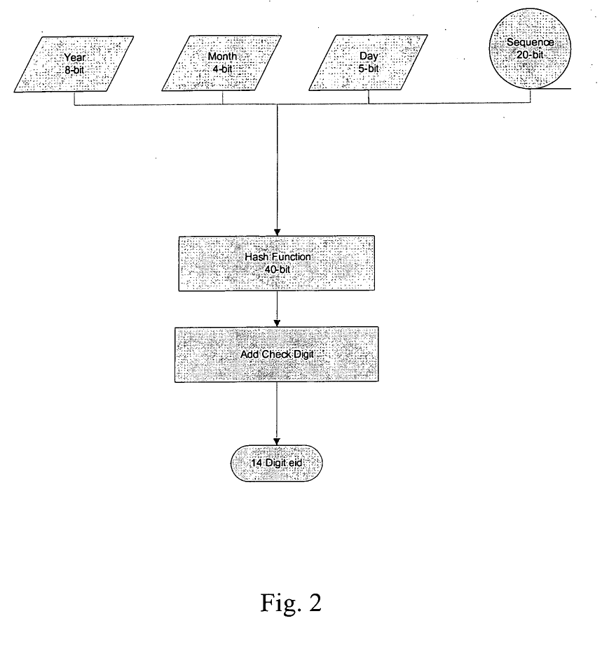

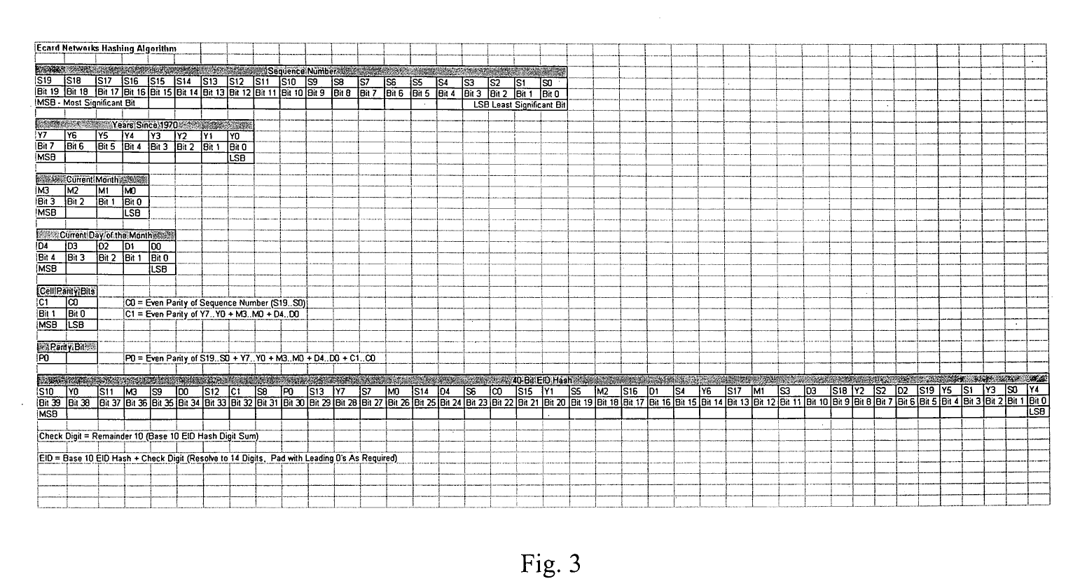

FIG. 2 illustrates one example of a preferred method of generating the EID number. The hash is developed with the following inputs: Year, Month, Day, and Sequence. The Sequence number (20-bit) is managed and provided by the database 10. These elements are binary hashed together to form a 40-bit binary number with 3 parity bits for verification. FIG. 3 illustrates the bit hash distribution. The 40-bit number (BASE 2) is then converted to a BASE 10 number (integer) of 13 digits. A final check digit is added to the end number to produce the final 14 digit EID. This produces a sparse array of EID's with an average distribution of 1 per 119 on a fully utilized array (i.e. the average numeric separation between numbers will be 119 after 1 million EID's have been generated per day for 256 years). The actual usage will be far lower than the stated maximum, and therefore the average numeric distribution will be far greater.

The EID Owner

The EID Owner, which may be an individual, a company or another entity, is the ‘owner’ of the card and administers the information contained on it. For a new customer the host website interface will offer the EID Owner a number of choices, such as whether the EID number should be searchable by job title or function or other fields, and whether the EID number should be portable (if yes, the EID is registered to the EID User, i.e. the person who's name appears on the business card; if no, the EID number is registered to the EID Owner and cannot be changed or transferred by the EID User without the EID Owner's permission). On the other hand, the EID number represents a specific individual, and is not intended to be represent a title or position (e.g. sales manager). If the Owner were permitted to change the User field, it would confuse holders of the EID number because they expect it to be associated with a specific individual. Accordingly, in the preferred embodiment EID contact information can be updated, but the EID Owner and EID User information fields must remain unchanged. If an EID User leaves the employ of the EID Owner or changes positions within the organization, new EID number would be assigned to his or her replacement.

All authorized changes to the business contact record are stored in the database 10, and thereafter whenever an EID Recipient (described below) accesses the business contact record they are provided with the most current information for that contact.

The EID User

The EID User is the individual whose name appears on the EID business card. The only activities required of the EID User are to update their information on the host website when their contact information changes (if they are also the EID Owner and therefore authorized to update card information), and where necessary to explain the functionality of the EID number to EID Recipients not familiar with the process.

The EID Recipient

The EID Recipient is the person to whom a business card, with an EID number, is given. The EID Recipient accesses the EID database. The first-time user must subscribe with the database host in order to access contact information associated with an EID. However, a first-time user may be allowed to use the database for a limited period of time, or be able to input a limited number of entries on a trial basis, before payment is required. Payments can be made by credit card, and annual renewals can be automatic.

Upon payment of the subscription fee, the first-time user has access to the EID database 10 through web server 20 and the host application 12. The host software 12 allows an unlimited number of EID numbers to be entered in a single session. Each number entry requires only fourteen keystrokes. The host software 12 thus allows the user to download contact information specific to EID numbers they have entered, into their default contact manager program by way of an applet 18 or third party plug-in module 16. The EID Recipient can then use their contact manager program to sort or search for business contacts by name, title, company, industry code, phone number, EID number, and/or any other field or combination of fields enabled as searchable by the client default contact manager program. This also allows the EID Recipient to access contact information when off-line, and preferably a synchronization routine is automatically invoked when the EID Recipient reconnects to the contact information database 10, to update the EID Recipient's contact manager program with any changes to the contact information since the EID Recipient's last login.

When the EID Recipient first accesses the EID database, the user interface shows no linked business cards. Each time the EID Recipient enters an EID number they are ‘linked’ to the associated business card record, and the contact name from that record will thereafter appear in the EID Recipient's list of linked business cards (stored in a user profile record in the database 10) unless deleted by the EID Recipient.

The EID Host Application

The EID host application 12 and database 10 are preferably resident on a single secure server (although they may reside on separate computers), and is accessed via the Internet over web server 20. EID Owner-related functions of the host application 12 may include: receiving owner information in pre-determined fields; checking for duplicated or incomplete information; requesting, receiving, and validating payment; issuing the EID number; and entering EID Owner information into searchable fields. The host application 12 may enable searching by many different means, including by key word (industry, job title, etc.).

Printer-related functions of the host application 12 may include: communication ability and compatibility with all major print/design software such as Quark and PageMaker, and all EID Owner-related functions described above.

EID Recipient-related functions of the host application 12 may include: verification of user identification (password or PIN); offering and accepting various payment options including credit or debit cards; accepting input of EID numbers and downloading of business contact information associated with the EID numbers into the user's default contact manager; searching for changes to business contact information for all EID-enabled contacts in the user's default contact manager; showing changes, and making changes in contact manager as instructed, and producing a report of all changes in select time frame, either user initiated or at designated intervals.

In the preferred embodiment the system of the invention allows for direct marketing via a discreet information field which allows the EID Owner or EID User (if authorized) to enter a business communications message such as a value proposition, slogan, feature/benefit statement or other message into the EID database. The message can be changed at any time. Each time the EID Recipient accesses the host web site this field is checked, and if the message has changed the EID Recipient's contact management program is updated. The new message is sent directly to the ‘Notes’ section of the EID Recipient's contact management program, so the EID Recipient sees the message only when accessing the EID User's information in the EID Recipient's contact management program. Alternatively, the message can be pushed to the EID Recipient's attention by an email messaging or similar system.

The EID database preferably also has anti-spam and anti-hacking safeguards which may limit the maximum number of contacts accessible from the database 10 in a single day, or allow a limited number of null entries before excluding a user from the system and optionally generating a security alert for the host.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A method of managing contact information, comprising the steps of:
a. providing an interface for the entry of user information to be stored in a contact information record in a system database,
b. generating a unique identification number associated with the user and the contact record, and
c. in response to entry of the identification number by a recipient into an interface, downloading information about the user from the contact information record to the recipient.

2. The method of claim 1 comprising, at any time after step b., disseminating the identification number in documentation associated with the user.

3. The method of claim 2 comprising, at any time after step b., downloading information from at least one record in the system database for creation of the documentation.

4. The method of claim 1 wherein the interface in step a. is provided on a web server and accessible through a browser program.

5. The method of claim 1 wherein the identification number is generated as one of a non-sequential sparse array of numbers.

6. The method of claim 5 wherein the identification number comprises a hash of a sequence number and the date that the identification number is generated.

7. The method of claim 1 wherein the contact record is administered by an owner other than the user, and can only be changed with the owner's authorization.

8. The method of claim 1 wherein when the recipient enters an identification number into the interface a recipient's contact manager program is linked to the contact record associated with the identification number.

9. The method of claim 8 wherein downloaded user information is stored in a recipient's database and updated each time the recipient accesses the system database.

10. The method of claim 1 wherein the interface comprises a field for entry of a business communications message.

11. A contact information management system, comprising:
a host computer equipped with an application for:
providing an interface for the entry of user information to be stored in a contact information record, and
generating a unique identification number associated with the user and the contact record, and
in response to entry of the identification number by a recipient into an interface, downloading information about the user from the contact information record to the recipient.

12. The system of claim 11 wherein the identification number associated with the user is disseminated in documentation.

13. The system of claim 12 comprising a third party program for downloading information from at least one record in the system database for creation of the documentation by a third party.

14. The system of claim 11 wherein the interface is accessible through a browser program.

15. The system of claim 11 wherein the identification number is generated as one of a non-sequential sparse array of numbers.

16. The system of claim 15 wherein the identification number comprises a hash of a sequence number and the date that the identification number is generated.

17. The system of claim 11 wherein the contact record is administered by an owner other than the user, and can only be changed with the owner's authorization.

18. The system of claim 11 wherein when the recipient enters an identification number into the interface a recipient's contact manager program is linked to the contact record associated with the identification number.

19. The system of claim 18 wherein downloaded user information is stored in a recipient's database and updated each time the recipient accesses the system database.

20. The system of claim 11 wherein the interface comprises a field for entry of a business communications message.
